(19) United States
(12) Patent Application Publication
(10) Pub. No.: US 2014/0109939 A1
(43) Pub. Date: Apr. 24, 2014

(54) NOZZLE APPARATUS AND METHODS FOR TREATING WORKPIECES

(71) Applicant: DÜRR ECOCLEAN GMBH, Filderstadt (DE)

(72) Inventors: Hermann-Josef David, Monschau (DE); Egon Kaske, Aachen (DE); Norbert Klinkhammer, Roetgen (DE)

(73) Assignee: DÜRR ECOCLEAN GMBH, Filderstadt (DE)

(21) Appl. No.: 14/137,154

(22) Filed: Dec. 20, 2013

Related U.S. Application Data
(63) Continuation-in-part of application No. PCT/EP2012/061355, filed on Jun. 14, 2012.

(51) Int. Cl. B08B 3/02

(52) U.S. Cl. CPC B08B 3/02
USPC 134/36; 134/103.2

(57) ABSTRACT

Nozzle apparatus and methods for treating workpieces are disclosed. An example apparatus includes a nozzle module and a first nozzle chamber disposed within the nozzle module. The first nozzle chamber has a first nozzle opening and is to deliver a relatively high pressure fluid to the first nozzle opening. The example apparatus also includes a second nozzle chamber disposed within the nozzle module and having a second nozzle opening, the second nozzle chamber to deliver a relatively low pressure fluid to a second nozzle opening. A first flow of the low pressure fluid at least partially contacts a second flow of the high pressure fluid. The second flow is directed onto a workpiece.

### RELATED APPLICATION

This patent arises from a continuation-in-part of International Patent Application No. PCT/EP2012/061355, which was filed on Jun. 14, 2012, which claims priority to German Patent Application No. 10 2011 078 076, which was filed on Jun. 24, 2011. The foregoing International Patent Application and German Patent Application are hereby incorporated herein by reference in their entireties.

### FIELD OF THE DISCLOSURE

This disclosure relates generally to apparatus and methods for treating workpieces, and, more particularly, to nozzle apparatus and methods for treating workpieces.

### BACKGROUND

During workpiece machining (e.g., material removal from engine components, cylinder heads, etc.), burrs are produced at the edges of recesses and bores. Moreover, during material-removal machining, workpieces may become contaminated with cooling lubricants and/or swarf. This contamination may cause faults during subsequent assembly processes and/or impair the technical functionality of systems produced from such contaminated workpieces. For example, in internal combustion engines, contamination in cylinder-head bores, and/or cooling lubricants or swarf in injection nozzles may result in the risk of irreparable engine damage.

In industrial production, a high-pressure water-jet technique may be used to deburr workpieces (e.g., unwanted burrs on a workpiece are exposed to a flow of a high-pressure liquid jet and detach from the workpiece due to an impulse transfer). To deburr workpieces by a high-pressure water-jet, nozzle modules may be used to generate a high-pressure liquid jet accelerating to a high flow velocity, vₛ, which may range from 10 meters/second (m/s) to 600 m/s.

Workpiece contamination may be substantially removed by flood washing, in which workpieces are fully or partially immersed in a fluid bath. This fluid bath is, for example, a cleaning medium in a liquid state under normal conditions and substantially at rest. In such fluid baths, a fluid jet with a relatively high mass flow rate may be applied to workpieces via nozzles.

Nozzles for flood washing are usually fully or partially submerged beneath the liquid level of the fluid bath in which a respective workpiece is immersed. Preferably, nozzle modules that have a fluid jet with a large flow cross section are used to flood wash workpieces, which results in a substantially large quantity of fluid transported per unit time (e.g., fluid flow rate). This fluid flow rate may be, for example, between 0.5 liters/second (Us) and 50 l/s at corresponding fluid flow velocities from 10 m/s to 200 m/s to allow the liquid surrounding the workpiece in the fluid bath to be rapidly exchanged and, thus, achieving highly effective cleaning.

An apparatus for flood-washing workpieces is described in EP2252413 B1. There, a cleaning and/or deburring apparatus is described that has a high-pressure fluid jet and a gas discharge device for producing a gas stream that envelopes the fluid stream.

### BRIEF DESCRIPTION OF THE DRAWINGS

FIG. 1 shows a section of a first example cleaning apparatus comprising a first example nozzle module in accordance with the teachings of this disclosure.

FIG. 2 shows a section of a second cleaning apparatus comprising a second example nozzle module.

FIG. 3 shows a longitudinal section of a third example nozzle module.

FIG. 4 shows a partial section along the line IV-IV of the third example nozzle of FIG. 3.

FIGS. 5 and 6 show the third example nozzle module in different nozzle positions.

FIG. 7 shows a longitudinal section of a fourth example nozzle module.

FIG. 8 shows a partial section of the fourth example nozzle module along the line VIII-VIII of FIG. 7.

FIG. 9 shows a longitudinal section of a fifth example nozzle module.

FIG. 10 shows a partial section of the fifth example nozzle module along the line X-X of FIG. 9.

FIG. 11 shows a longitudinal section of a sixth example nozzle module.

FIG. 12 shows a partial section of the sixth example nozzle module along the line XII-XII of FIG. 11.

FIG. 13 shows a longitudinal section of a seventh example nozzle module.

FIG. 14 shows a partial section of the seventh example nozzle module along the line XIV-XIV of FIG. 13.

FIG. 15 shows a longitudinal section of an eighth example nozzle module.

FIG. 16 shows a partial section of the eighth example module along the line XVI-XVI of FIG. 15.

FIGS. 17A-17E shows nozzle opening geometries for a high-pressure liquid nozzle in a nozzle module.

The figures are not to scale. Instead, to clarify multiple layers and regions, the thicknesses of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

The examples described herein relate to example nozzle modules and/or apparatus that use a constant or pulsing high-pressure liquid jet flowing through a nozzle opening in a nozzle chamber of a nozzle module and combine the high-pressure liquid jet with a second jet of fluid such that the high-pressure liquid jet undergoes substantially decreased deceleration as it flows through a liquid bath to flood-wash and/or deburr workpieces in the liquid bath (e.g., a cleaning liquid).

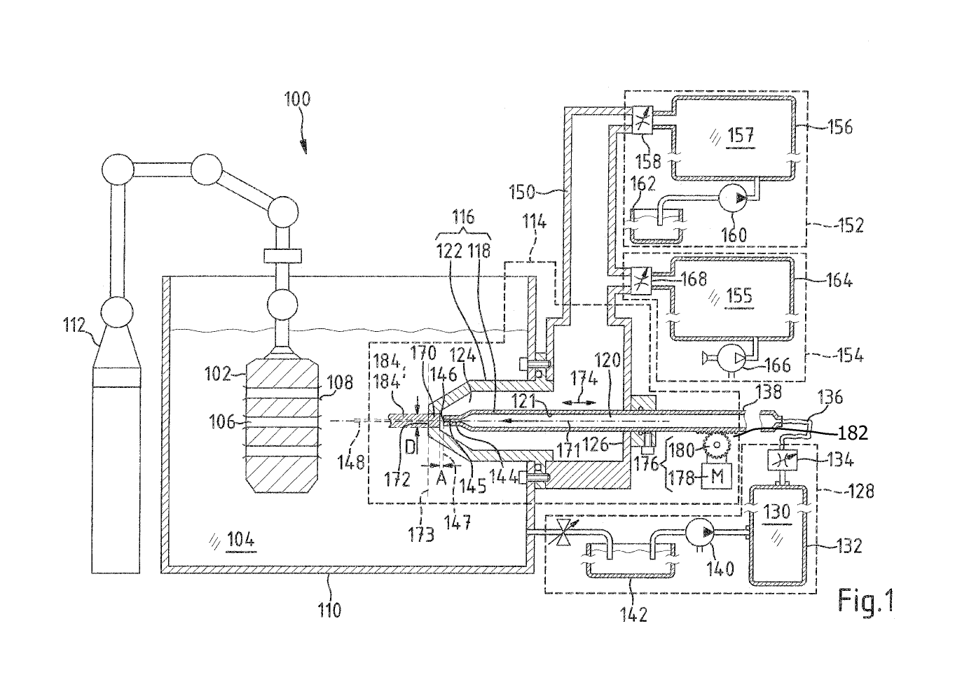

FIG. 1 shows a section of an example cleaning apparatus 100 to flood wash a workpiece 102 in a liquid bath 104 in accordance with the teachings of this disclosure. The cleaning apparatus 100 is a treatment apparatus for workpieces 102 that, in some examples, may be cylinder heads made of aluminum and having a plurality of bores 106. In order to produce the bores 106, a workpiece 102 has undergone material-removal machining at a machining center. In the cleaning apparatus 100, the workpiece 102, or any other suitable workpiece, is not only substantially cleaned of contaminants in the form of cooling lubricants and swarf, but the workpiece 102 may also be debarred (i.e., burrs 108 caused by material-removal machining at the machining center are removed from the workpiece 102).

The liquid bath 104 is located in a liquid tank 110. In this example, the cleaning apparatus 100 includes a handling robot 112 that may pick up the workpiece 102 in the cleaning apparatus 100 and manipulate the workpiece 102 in three translational and three rotational degrees of freedom within the liquid bath 104.

To clean and/or deburr the workpiece 102, the cleaning apparatus 100 comprises a nozzle module 114, which has a module body 116. The module body 116 has a nozzle body 118 defining a nozzle chamber 120 with a wall 121. The module body 116 has a second nozzle body 122 with a second nozzle chamber 124. The second nozzle body 122 projects into the liquid tank 110. The nozzle body 118 is disposed within the second nozzle body 122 and extends through a wall 126 of the nozzle body 122.

The nozzle chamber 120 is fluidly coupled to a device 128 that provides liquid 130 at a substantially high pressure and has a pressure vessel 132, which is fluidly coupled to, via a proportional valve 134 and a hose line 136, a pipeline 138. The pipeline 138, in turn, is fluidly coupled to the nozzle chamber 120. The device 128 also includes a pump 140 to charge the pressure vessel 132 with liquid from a fluid reservoir 142.

The nozzle body 118 comprises a nozzle mouth 144 that has a nozzle opening 146. The nozzle opening 146 is substantially coaxially aligned with a nozzle opening 172.

When the pressure vessel 132 has been charged with liquid from the fluid reservoir 142, a high-pressure liquid jet 148 may be provided through the nozzle opening 146. The nozzle chamber 124 in the nozzle module 114 is fluidly coupled to, via a line system 150, a device 152 that provides pressurized liquid and to a device 154 that, in turn, provides pressurized gaseous fluid 155.

The device 152 that provides pressurized liquid 157 includes a pressure vessel 156 that may be fluidly coupled to the nozzle chamber 124 via a proportional valve 158. The device 152 also includes a pump 160 to charge the pressure vessel 156 with liquid from a fluid reservoir 162.

The device 154, that provides pressurized gaseous fluid, has a pressure vessel 164. Compressed air may be applied to the pressure vessel 164 via a compressor 166. The line system 150 of the example of FIG. 1 includes a proportional valve 168 that, when opened, may provide the nozzle chamber 124 with gaseous fluid.

The nozzle chamber 124 in the second nozzle body 122 has a nozzle opening 170 that has an axis 171 and a nozzle opening 172. The nozzle mouth 144 has an axis 145. The axis 171 of the nozzle opening 170 is substantially coaxially aligned with the axis 145. In some examples, the nozzle opening 172 may preferably be circular, though some other nozzle opening geometries are possible. The nozzle opening 172 has an opening diameter, D, that, in this example, may advantageously range from 10 millimeters (mm) to 20 mm.

The nozzle body 118 may be displaced within the nozzle module 116 in directions generally indicated by a double arrow 174. To displace the nozzle body 118, the nozzle module 116 may have an electric drive 176 comprising an electric motor 178. The electric motor 178 causes a drive pinion 180 that meshes with a toothed rack 182 on the pipeline 138 to rotate. Additionally or alternatively, a pneumatic or hydraulic drive may also be used instead to displace the nozzle body 118. In one example, a hydraulic drive, for example, operated with a cleaning medium may be advantageous.

The cleaning apparatus 100 may be operated in a first mode to clean the workpiece 102 and in a second mode to deburr the workpiece 102. Alternatively, the cleaning apparatus 100 may clean and deburr simultaneously.

In this example, to deburr a workpiece 102 in the cleaning apparatus 100, liquid 130 is applied into the nozzle chamber 120 from the device under a substantially high liquid pressure, P_{F}, preferably ranging from 50 bar to 3000 bar. In this example, the liquid may preferably be a cleaning medium (e.g., water). However, the liquid may be, for example, an emulsion or an oil. In this example, simultaneous with the liquid being applied to the nozzle chamber 120, pressurized gaseous fluid is provided to the nozzle chamber 124 from the device 154 at a positive pressure, P_{G}, relative to atmospheric pressure that preferably may range from 0.01 bar to 3000 bar. The gaseous fluid may be, for example, air, a gas mixture and/or water vapor.

The high-pressure liquid jet 148 flowing out of the nozzle opening 146 caused by high-pressure liquid being applied into the nozzle chamber 120 is surrounded by an annular low-pressure fluid stream 184 of gaseous fluid from the nozzle chamber 124. The low-pressure fluid stream 184 flows concurrently with the high-pressure liquid jet 148. The low-pressure fluid stream 184 of gaseous fluid thereby shields the high-pressure liquid jet 148 in the liquid bath 104 from the liquid in the liquid tank 110. The low-pressure fluid stream 184 of gaseous fluid substantially reduces the exposure of the high-pressure liquid jet 148 to frictional forces. The result is that loss of the kinetic energy of the liquid in the high-pressure liquid jet 148 is substantially reduced as the workpiece 102 is deburred. Therefore, the kinetic energy of the high pressure liquid jet is also not substantially dissipated into the liquid bath 104 between the nozzle opening 146 of the nozzle chamber 120 and the workpiece 102. This shielding of the high-pressure liquid jet 148 by the annular fluid jet 184 is particularly effective in examples in which the distance, A, of the plane 147 of the nozzle opening 146 from the nozzle opening 170 is approximately equal to the opening diameter, D, of the nozzle opening 172. In this example, the distance, A, may preferably be in a range from 10 mm to 20 mm.

Alternatively, to clean the workpiece 102 in the liquid bath 104, pressurized liquid, instead of gaseous fluid, may be applied through the nozzle chamber 124 from the pressure vessel 156. Therefore, the pressurized liquid from the pressure vessel 156 emerges with an annular low-pressure fluid jet 184′ composed of liquid from the nozzle opening 146 of the nozzle chamber 120, and flows concurrently with the high-pressure liquid jet 148 in the liquid bath 104. The ring jet 184′ contacts and surrounds the high-pressure liquid jet 148. The annular low-pressure fluid jet 184′ of liquid is, thus, accelerated by the high-pressure liquid jet 148. This acceleration enables a large stream of liquid to be applied to the workpiece 102. As a result, dirt particles, contaminants and/or swarf adhering to the surface of the workpiece 102 are displaced into the liquid bath 104 within a relatively short period of time.

In some examples, a substantially efficient acceleration of the ring jet 184′ by the high-pressure liquid jet 148 may be achieved when the nozzle body 118 is displaced by the electric drive 176 to allow the nozzle opening 146 to be located in front of the plane 173, and the nozzle opening 172 is substantially perpendicular to the jet axis 171 on the side of the nozzle module 116 substantially facing the workpiece 102.

In one example, the liquid bath 104 in the cleaning apparatus 100 advantageously consists of substantially heated water that may include cleaning additives (e.g., cleaning additives in the form of alkali hydroxides, silicates, phosphates, borates and carbonates and/or cleaning additives in the form of non-ionic surfactants or cationic surfactants).

In one example, to clean the workpiece 102, the high-pressure liquid jet 148 in the cleaning apparatus is preferably composed of water, water containing anti-corrosion and cleaning additives, emulsion, and/or oil, etc. In this example, the ring jet or ring stream 184 is preferably composed of water, water containing anti-corrosion, cleaning additives, and/or emulsion, etc.

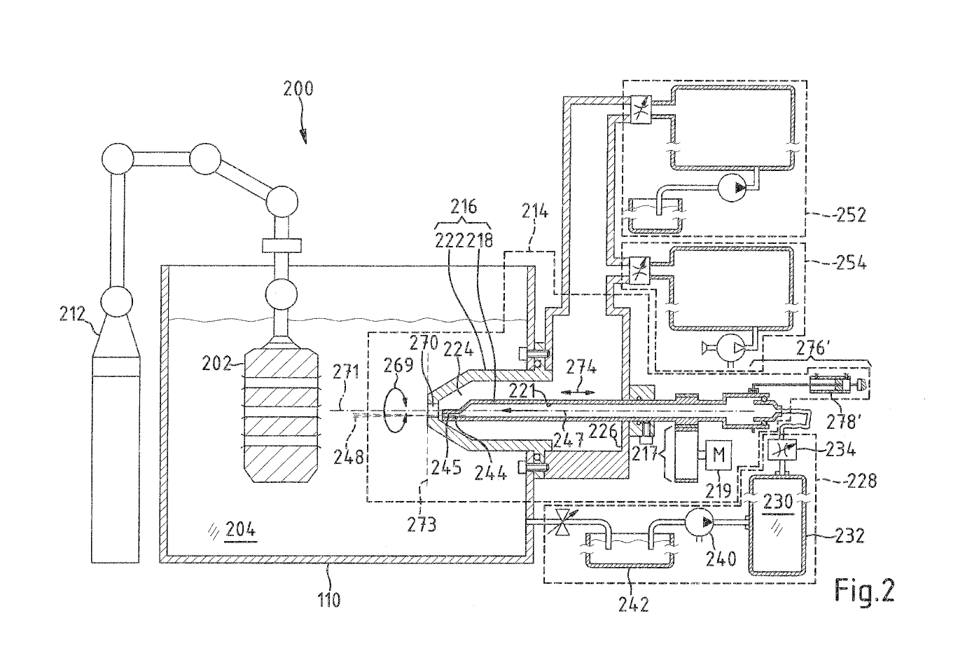

FIG. 2 shows a section of a second example cleaning apparatus 200 to flood wash a workpiece 202. Insofar as the elements of FIG. 2 are substantially similar to elements in FIG. 1, they are denoted therein by numbers, as reference numerals, incremented by the number 100 with respect to FIG. 1.

The nozzle module 216 of the cleaning apparatus 200 has a nozzle body 218 comprising a nozzle mouth 244. Unlike the nozzle module 114 in the cleaning apparatus 100, the axis 245 of the nozzle mouth 244 of the nozzle chamber 220 is offset with respect to the axis 271 of the nozzle opening 270. The nozzle body 218 of the nozzle module 214 is rotatably mounted onto the nozzle body 222. To rotate the nozzle body 218, the nozzle module 216 has a drive 217 with an electric motor 219. The nozzle body 218 may be rotated, via the drive 217, about the axis 271 in directions generally indicated by a double arrow 269.

The nozzle module 216 has a drive 276′ with a pneumatic cylinder 278′ that enables the nozzle body 218 to be displaced in a linear direction within the nozzle module 114 in directions generally indicated by a double arrow 274.

Similar to the cleaning apparatus 100, the cleaning apparatus 200 may be operated in a cleaning mode and/or a deburring mode for the workpiece 202. Because the nozzle mouth 244 is rotated about the axis 271, a high-pressure liquid jet 248 from the nozzle chamber 220 may cause a tumbling movement of the workpiece 202, thereby allowing the high-pressure liquid jet 248 to be applied to a relatively larger workpiece surface than the cleaning apparatus 100.

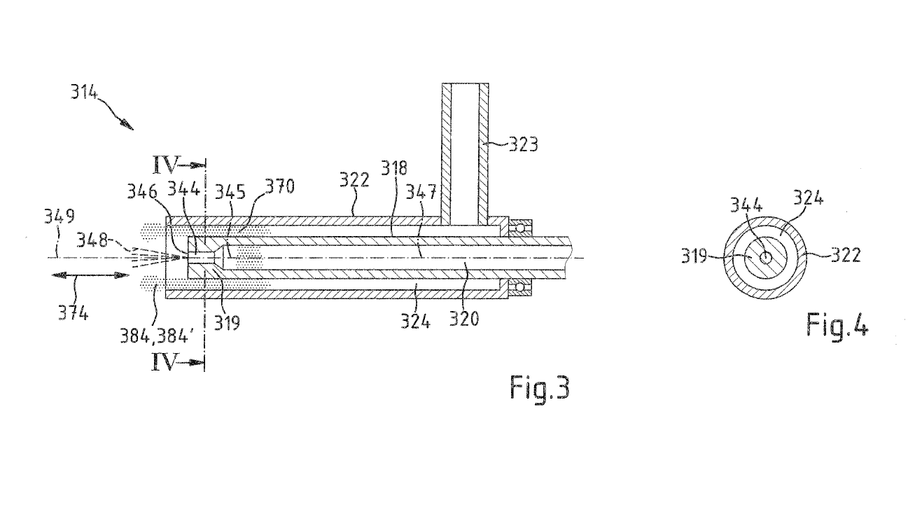

FIG. 3 shows a longitudinal section of a third example nozzle module 314 for use in a treatment apparatus for treating workpieces (e.g., a cleaning apparatus as described previously). The nozzle module 314 has a first tubular nozzle body 322. A second tubular nozzle body 318 has a nozzle chamber 320 and is disposed within the first tubular nozzle body 322. The nozzle body 318 has a nozzle opening 319 that has a nozzle mouth 344. The nozzle mouth 344 has an axis 345 that corresponds to an axis 347 of the tubular nozzle body 318, and is substantially coaxially aligned with the first tubular nozzle body 322. Thus, an axis 349 of the first tubular nozzle body 322 is in substantial alignment with the axis 347. The first tubular nozzle body 322 has a nozzle chamber 324, to which gaseous fluid or liquid may be applied via a connector piece 323. The nozzle body 318 is disposed within the first tubular nozzle body 322 and may be displaced within the first tubular nozzle body 322 in directions generally indicated by a double arrow 374.

FIG. 4 shows a partial section of the nozzle module 314 along the line IV-IV of FIG. 3. The nozzle chamber 324 in the first tubular nozzle body 322 has an annular cross section.

The nozzle body 318 generates a substantially high-pressure liquid jet 348 that exits the nozzle chamber 320 through a nozzle opening 346 of the nozzle chamber 320. Similar to the nozzle module 114 of FIG. 1 and the nozzle module 214 of FIG. 2, a high-pressure liquid jet 348 of the nozzle module 314 emerges from the nozzle opening 346 and may be surrounded by a low-pressure fluid stream 384, 384′ of pressurized gas (e.g., compressed air) or pressurized liquid that emerges from the opening 370 of the nozzle chamber 324.

The high-pressure liquid jet 348 is enveloped by the fluid stream 384, 384′, that has an annular cross section and flows concurrently with the high-pressure liquid jet 348 emerging from the nozzle opening 346. As a distance from the nozzle opening 372 increases, the low-pressure fluid stream 384, 384′ increases contact with the high-pressure liquid jet 348.

FIG. 4 is a partial section the nozzle module 314 in an example where the nozzle opening 346 in the tubular nozzle body 318 is disposed in an offset manner in relation to the end face 371 of the first tubular nozzle body 322.

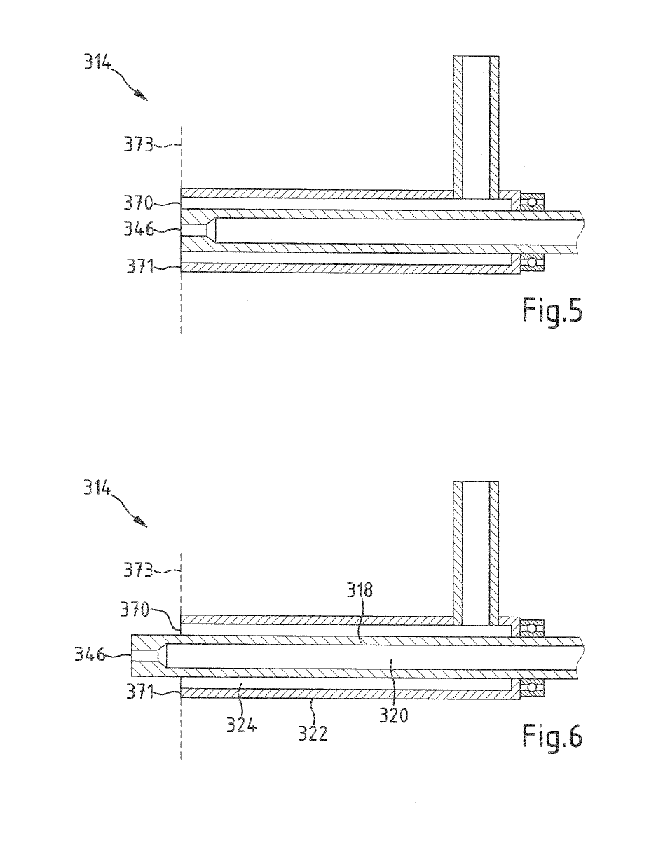

FIGS. 5 and 6 show the third example nozzle module 314 in different nozzle positions. In FIG. 5, the nozzle module 314 is shown where the nozzle opening 346 is substantially aligned with the plane 373 of the end face 371. FIG. 6 shows the nozzle module 314 in a position during use, in which the nozzle opening 346 is positioned on a side corresponding to the workpiece (i.e., in front of the plane 373).

FIG. 7 shows a longitudinal section of a fourth example nozzle module 414 for treating workpieces. The nozzle module 414 has a tubular nozzle body 422. A second tubular nozzle body 418, that has a nozzle chamber 420, is disposed within the nozzle body 422. The nozzle body 418 has a nozzle opening 419 that, in turn, includes a nozzle mouth 444. The nozzle mouth 444 has an axis 445 that corresponds to the axis 447 of the tubular nozzle body 418. The nozzle body 418 is substantially coaxially aligned with the nozzle body 422 and, thus, the axis 449 of the nozzle body 422 is substantially aligned with the axis 447. The nozzle body 422 has a nozzle chamber 424, to which gaseous fluid or liquid may be applied into via a connector piece 423. The nozzle body 418 is disposed within the nozzle body 422 and is supported by two bearings 425, 426, that are spatially separated. The nozzle body 418 may be displaced within the nozzle body 422 in directions generally indicated by a double arrow 474.

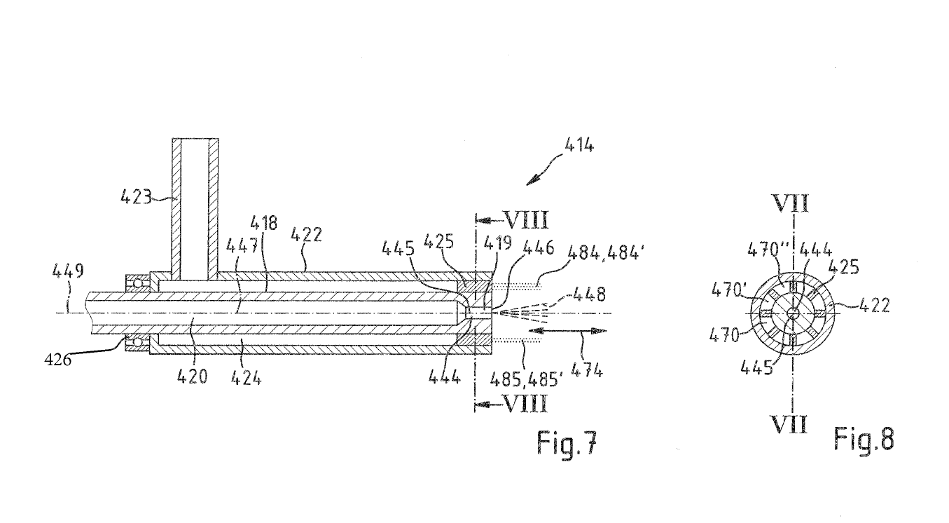

FIG. 8 shows a partial section of the nozzle module 414 along the line VIII-VIII of FIG. 7. The nozzle chamber 424 in the nozzle body 422 has an annular cross section. The bearing 425 in the nozzle chamber 422 has a plurality of nozzle openings 470, 470′, 470″ that are separated by annular gaps. The nozzle body 418 is guided in a substantially linear direction and supported at the bearings 425, 426.

The nozzle body 418 generates a high-pressure liquid jet 448 that exits the nozzle chamber 420 through a nozzle outlet 446. The bearings 425, 426 of the nozzle body 418 substantially prevent the nozzle mouth 444, which has the nozzle outlet 446, from moving when high pressure is applied into the nozzle chamber 420. Similar to the nozzle module 114 of FIG. 1 and the nozzle module 214 of FIG. 2, a high-pressure liquid jet 448 emerging from the nozzle outlet 446 of the nozzle module 414 may be surrounded by fluid streams 484, 485, 484′, 485′ of pressurized gas (e.g., compressed air) or pressurized liquid emerging from the openings 470, 470′, 470″ of the nozzle chamber 424.

The fluid streams 484, 485, 484′, 485′ flow concurrently with the liquid jet 448. As distance from the nozzle openings 470, 470′, 470″ increases, the fluid streams 484, 485, 484′, 485′, in a substantially uniformly distributed manner, increase contact to the high-pressure liquid jet 448 exiting the nozzle outlet 446. Due to widening of the jet 448, the fluid streams 484, 485, 484′, 485′ surround the high-pressure liquid jet 448 in a portion that is at a distance from the nozzle openings 470, 470′, 470″ and the nozzle outlet 446.

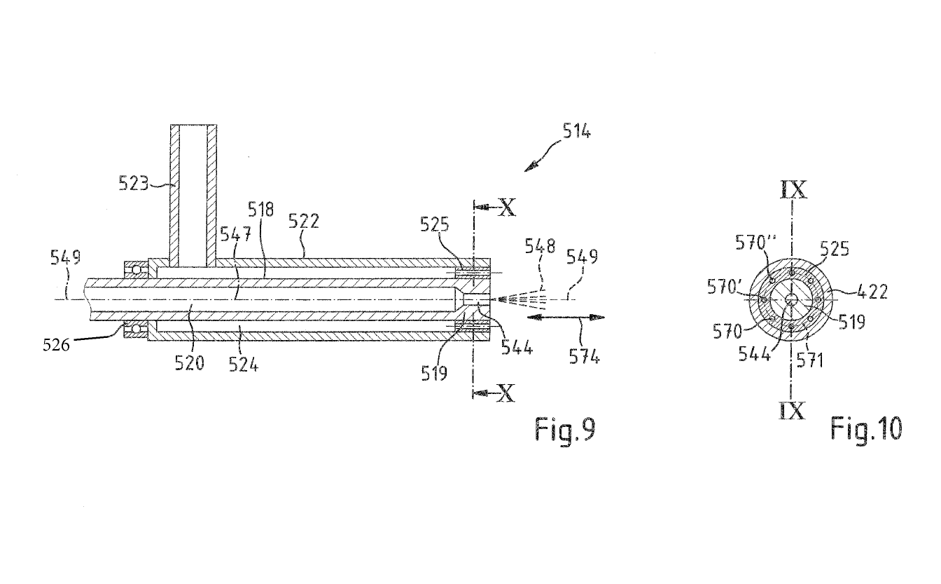

FIG. 9 shows a longitudinal section of a fifth example nozzle module 514. In FIG. 10, the nozzle module 514 is shown in a partial section along the line X-X of FIG. 9. The nozzle module 514 has a tubular nozzle body 522. The structure of the nozzle module 514 is substantially similar to the structure of the nozzle module 414 described in connection with FIGS. 7 and 8. Elements in FIGS. 9 and 10 that correspond functionally to the elements of FIGS. 7 and 8 are, therefore, denoted therein by numbers as reference numerals incremented by the number 100. Unlike the nozzle chamber 422 of the nozzle module 414, the nozzle body 522 in the nozzle module 514 has nozzle opening 525 containing a plurality of nozzle openings 570, 570′, 570″ in the shape of substantially circular holes. The nozzle openings 570, 570′, 570″ are positioned on a notional circle line 571 that is substantially coaxially aligned with the axis 544 of the nozzle opening 548. The nozzle body 518 is guided in a linear manner within the nozzle opening 525 of the nozzle body 522. Within the nozzle module 514, the nozzle body 518 is supported at two bearings 525 and 526.

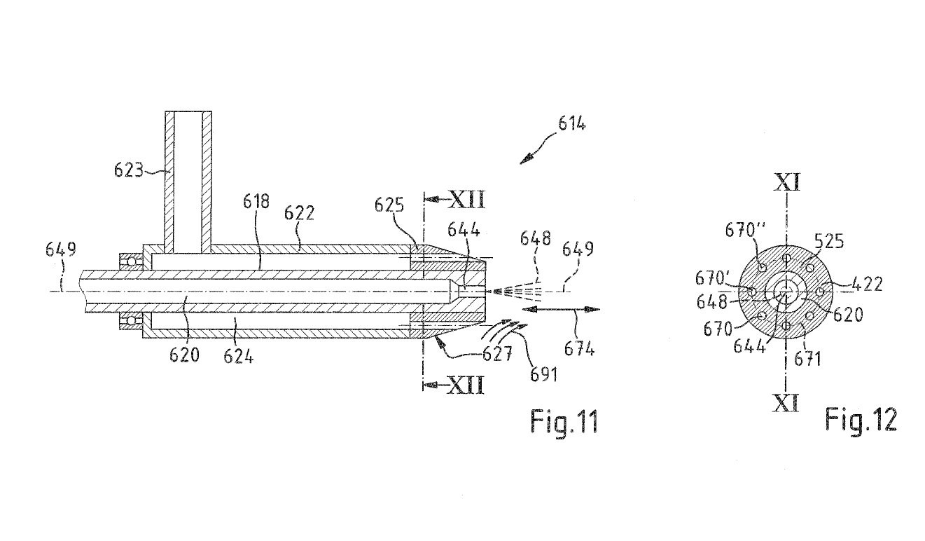

FIG. 11 shows a longitudinal section of a sixth example nozzle module 614. In FIG. 12, the nozzle module 614 is shown in a cross section along the line XII-XII of FIG. 11. The nozzle module 614 has a tubular nozzle body 622. The structure of the nozzle module 614 is substantially similar to the structure of the nozzle module 414 described in connection with FIGS. 7 and 8. Elements in FIGS. 11 and 12 that correspond functionally to the elements of FIGS. 7 and 8 are, therefore, denoted therein by numbers as reference numerals incremented by the number 200. Unlike the nozzle chamber 422 of the nozzle module 414, the nozzle body 622 in the nozzle module 614 has a nozzle opening 625 with a plurality of nozzle openings 670, 670′, 670″ with substantially circular hole shapes. The nozzle openings 670, 670′, 670″ are positioned on a notional circle line 671 that is coaxial with the axis 644 of the nozzle opening 648. The nozzle opening 625 has the outer contour 627 of a truncated pyramid to allow a medium flowing out of the nozzle openings 670, 670′, 670″ and into the liquid bath draws liquid from the liquid bath, in a direction of flow generally indicated by arrows 691, and entrains and moves the liquid through the liquid bath. Consequently, the liquid may be accelerated in the vicinity of the high-pressure liquid jet 648 by the medium flowing out of the nozzle openings 670, 670′, 670″ resulting in a substantially powerful high-pressure liquid jet 648 injected into the liquid bath and directed onto a workpiece within the liquid bath.

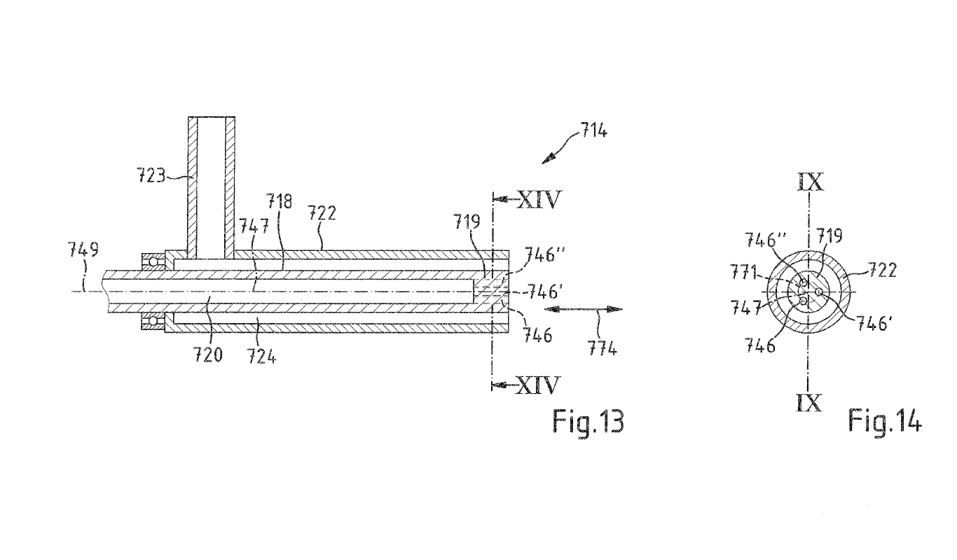

FIG. 13 shows a longitudinal section of a seventh example nozzle module 714. In FIG. 14, the nozzle module 714 is shown in a partial section along the line XIV-XIV of FIG. 13. The nozzle module 714 has a tubular nozzle body 722. The structure of the nozzle module 714 is substantially similar to the structure of the nozzle module 414 described in connection with FIGS. 7 and 8. Elements in FIGS. 13 and 14 that correspond functionally to the elements of FIGS. 7 and 8 are, therefore, denoted by numbers as reference numerals incremented by the number 300. Unlike the nozzle chamber 420 of the nozzle module 414, the nozzle body 718 in the nozzle module 714 has a nozzle opening 719 with a plurality of nozzle openings 746, 746′, 746″ that have substantially circular-shaped holes. The nozzle openings 746, 746′, 746″ are positioned on a notional circle line 771 that is coaxial with an axis 747 of the nozzle body 718 and with an axis 749 of the nozzle body 722. The nozzle module 714, thus, enables a substantially high-pressure liquid jet, or a plurality of substantially high-pressure liquid jets, to be applied to a relatively large workpiece surface area.

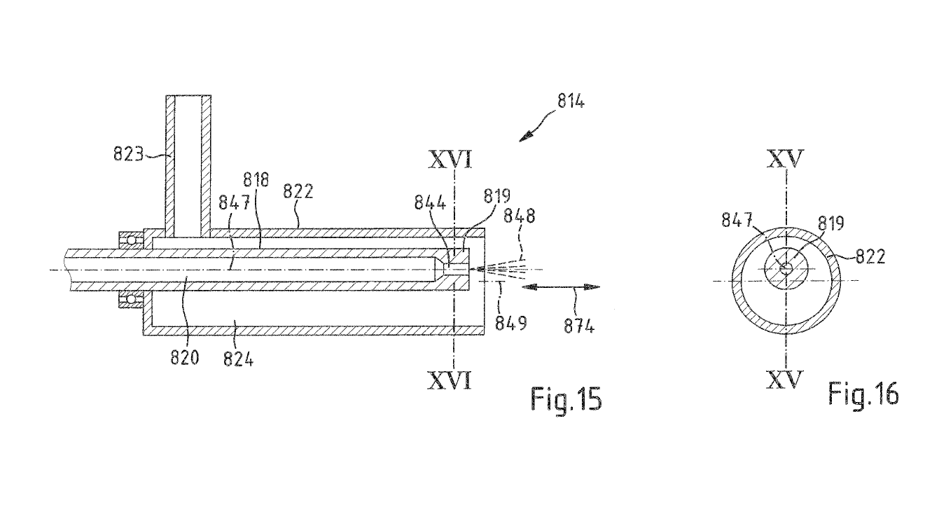

FIG. 15 shows a longitudinal section of a nozzle module 814. In FIG. 16, the nozzle module 814 is shown in a partial section along the line XVI-XVI of FIG. 15. The nozzle module 814 has a tubular nozzle body 822. The structure of the nozzle module 814 is substantially similar to the structure of the nozzle module 414 described in connection with FIG. 7 and FIG. 8. Elements in FIGS. 15 and 16 that correspond functionally to the elements of FIGS. 7 and 8 are therefore denoted therein by numbers as reference numerals incremented by the number 400. Unlike the nozzle chamber 420 of the nozzle module 414, a nozzle body 818 has a nozzle opening 819 in the nozzle module 814 having an axis 847 that is disposed in an offset manner in relation to an axis 849 of the tubular nozzle body 822. The nozzle module 814, therefore, generates a high-pressure liquid jet 848 that, in a liquid bath, is substantially surrounded at a substantially great distance into the fluid bath by an air cushion generated by compressed air flowing into the nozzle chamber 824.

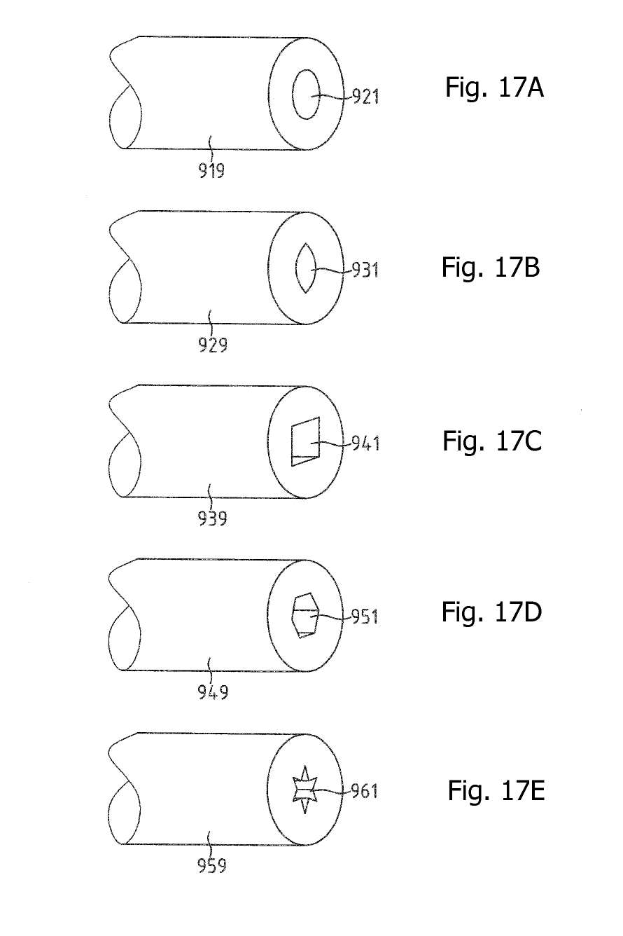

FIGS. 17A-17E show example nozzle openings (e.g., orifice, mouthpiece, mouth, etc.) geometries for generating a high-pressure liquid jet in a nozzle module as previously described.

As shown in FIG. 17A, a nozzle opening 919 has an orifice with a circular nozzle opening 921 defined by a hole, such as a drilled hole. The nozzle opening 919 allows a high-pressure liquid jet with a circular jet cross section to be generated in a nozzle module.

As shown in FIG. 17B, a nozzle opening 929 has a nozzle opening 931 with an oblong cross section, such as a substantially lenticular cross section. The nozzle opening 931 allows a high-pressure liquid jet with a substantially oblong, oval, and/or flattened cross section to be generated in a nozzle module. This liquid jet allows processing of a workpiece with a wide processing track while the workpiece is moved transversely in relation to the high-pressure liquid jet during processing.

As shown in FIG. 17C, a nozzle opening 939 has a nozzle opening 941 with a substantially quadrangular cross section. The nozzle opening 939 allows generation of a high-pressure liquid jet with a quadrangular cross section.

As shown in FIG. 17D, a nozzle opening 949 has a nozzle opening 951 with a substantially hexagonal cross section. The nozzle opening 949 allows generation of a high-pressure liquid jet with a hexagonal cross section.

As shown in FIG. 17E, a nozzle opening 959 has a nozzle opening 961 with a substantially star-shaped cross section. The nozzle opening 959 allows generation of a high-pressure liquid jet with a star-shaped cross section.

Some preferred example cleaning apparatus 100, 200 for treating (e.g., cleaning and/or deburring) workpieces 102, 202 include a nozzle module 114, 214. The nozzle module 114, 214 includes a module body 116, 216 which, in turn, includes a nozzle chamber 120, 220. The nozzle chamber 120, 220 has at least one nozzle opening 146, 246 to generate at least one high-pressure liquid jet 148, 248 directed onto a workpiece 102, 202. The module body 116, 216 comprises a second nozzle chamber 124, 224 that has at least one nozzle opening 172, 272 to generate at least one low-pressure fluid jet 184, 184′, 284, 284′ flowing at least partially along and contacting the high-pressure liquid jet 148, 248. The cleaning apparatus 100, 200 also includes a device 128, 228 for delivering high pressure liquid 130, 230 into the nozzle chamber 120, 220 to generate the at least one high-pressure liquid jet 148, 248 directed towards the workpiece 102, 202. The apparatus may also include a device 154, 254 for delivering liquid 157 under low pressure or gaseous fluid 155 into the second nozzle chamber 124, 224.

The systems and structures described herein relate to an apparatus for treating (e.g., cleaning and/or deburring) workpieces. The apparatus includes a nozzle module that has a module body which, in turn, comprises a nozzle chamber with at least one nozzle opening to generate at least one high-pressure liquid jet directed towards a workpiece. The module body comprises a second nozzle chamber that has at least one nozzle opening to generate at least one low-pressure fluid jet flowing at least partially along and contacting the high-pressure liquid jet, and comprising a device for delivering liquid under high pressure into the nozzle chamber to generate the at least one high-pressure liquid jet.

Some examples disclosed herein describe an apparatus for treating workpieces by which, through setting differing operating states, different types of workpiece treatment such as, for instance, cleaning and/or deburring, may be performed.

The examples disclosed herein describe an apparatus for treating (e.g., cleaning and/or deburring) workpieces that, in addition to having the device to deliver substantially high pressure liquid into the nozzle chamber, has a device to deliver low pressure liquid or gaseous fluid into the second nozzle chamber.

The term high-pressure liquid jet as described herein is defined as a liquid jet generated by liquid guided through a nozzle opening that is subjected to a positive pressure, relative to the environment, of approximately at least 10 bar. In contrast, the term low-pressure fluid jet refers to a fluid jet generated by gaseous or liquid fluid guided through a nozzle opening that is subjected to a lower positive pressure than the liquid in the high-pressure liquid jet.

In some examples, the high-pressure liquid jet directed towards the workpiece may have a substantially constant liquid flow. Alternatively, the liquid jet may also have a liquid flow that pulses in a regular or irregular manner. The fluid from the at least one second nozzle chamber may alternatively be provided with uniform or non-uniform pulses. The fluid from the at least one second nozzle chamber influences, in particular, shapes, deflects and/or shields the high-pressure liquid jet. Systems based on the examples described preferably enable the flow velocity, vₛ, to be within a defined range.

The examples described herein may substantially increase the deburring and/or cleaning effectiveness of a high-pressure liquid jet directed towards a workpiece immersed in a liquid bath (e.g., in a cleaning bath) with an additional second jet, or stream, of gaseous fluid flowing along the high-pressure liquid jet due to frictional force reduction of the high-pressure liquid jet. Additionally, due to the Venturi effect, the high-pressure liquid jet in a cleaning bath is accelerated by a second liquid jet, or liquid stream flowing concurrently with the high-pressure liquid jet, thereby increasing the liquid mass directed onto the liquid jet to the workpiece in the cleaning bath.

In some examples, a constant or pulsing high-pressure liquid jet is generated by a nozzle opening in a nozzle chamber of a nozzle module to deburr workpieces in a liquid bath. In particular, a cleaning liquid is combined with a second jet of gaseous fluid so that the high-pressure liquid jet undergoes less deceleration in the liquid bath. Alternatively or additionally, the high-pressure liquid jet for flood washing of workpieces may be used to accelerate a second liquid jet, or liquid stream, to increase the liquid mass flow rate directed towards the workpiece. In particular, the second jet may have an annular cross section so that the high-pressure jet is at least partially surrounded by the second jet and may be shielded transversely in relation to the flow direction from surrounding fluid.

Because the at least one second fluid jet at least partially contacts the liquid jet, the frictional forces encountered by the high pressure liquid jet may be substantially low. The at least one second fluid jet not only increases the range of a high-pressure liquid jet in the cleaning medium, but also improves the acceleration capability of the high-pressure liquid jet. Because the second fluid jet or liquid stream from the second nozzle chamber surrounds the high-pressure fluid jet in the cleaning bath, the frictional forces between the high-pressure liquid jet and a cleaning liquid may be reduced. Because of the large interfacial area between the high-pressure fluid jet and the second fluid jet, the high-pressure fluid jet may create a substantially large acceleration effect for the second fluid jet. In some examples, the temperature of the fluid in the high-pressure liquid jet and the temperature of the second fluid jet may differ.

Some examples disclosed herein describe a nozzle opening of the first nozzle chamber to be displaced relative to the nozzle opening of the second nozzle chamber within the module body or vice-versa. In particular, the at least one nozzle opening of the first nozzle chamber, which is located in a nozzle mouth, is disposed in a substantially linearly movable manner that may be moved along an axis that is substantially parallel to the jet axis of the nozzle mouth. Because the nozzle openings may be adjusted relative to one other, the fluid jets may be substantially matched. In particular, because a position of at least one of the nozzle openings may be altered in the flow direction, the effect of the second fluid jet from the second nozzle chamber, on the first high-pressure jet may be adjusted according to requirement(s). Additionally or alternatively, the shape and behavior of the first high-pressure jet may be influenced to requirement(s), varying the pressure of the fluid, and/or through fluid selection.

In such examples, it is advantageous if the at least one nozzle opening of the first nozzle chamber is rotatably movable about a rotation axis that is substantially parallel to the jet axis of the nozzle opening. This rotatably movable nozzle opening enables a high-pressure fluid jet to be applied to substantially large workpiece surfaces.

In some examples, it is additionally advantageous if the nozzle opening is positioned in the module body in such a manner that the plane that comprises the nozzle opening and perpendicular to the jet axis of the nozzle opening, is located in front of, in or behind a plane that comprises the at least one nozzle opening of the second nozzle chamber and that is perpendicular to the jet axis of the nozzle opening, in the orientation of the flow direction of a fluid jet emerging from the nozzle opening.

In some examples, the at least one nozzle opening of the first nozzle chamber is shaped, advantageously, with a circular shape, a lenticular shape, a quadrangular shape, a hexagonal shape or a star shape, thereby allowing generation of a first high-pressure fluid jet having a cross section that is, in particular, suitable for deburring workpieces. In some examples, it is particularly advantageous for the nozzle opening to be disposed within an interchangeable diaphragm located within the nozzle opening region.

In some examples, the first nozzle chamber may have a plurality of nozzle openings for generating a plurality of fluid jets directed towards the workpiece. In some examples, the at least one first nozzle chamber preferably has a wall that extends at least partially through the second nozzle chamber. In some examples, the at least one nozzle opening of the at least one second nozzle chamber has the shape of a ring or ring segment.

In some examples, the at least one second nozzle chamber may have a plurality of nozzle openings for generating a plurality of second fluid jets flowing along the first fluid jet. In some examples, the plurality of nozzle openings for generating a plurality of second fluid jets that at least partially contact the first fluid jet are preferably shaped as ring segments or circle areas disposed around a common center. Because the at least one second nozzle chamber is disposed in a nozzle body with a tapered outer contour, in which the plurality of nozzle openings are located, an improved injection effect into a fluid bath may be achieved for a high-pressure fluid jet exiting the first nozzle chamber.

In some examples, the nozzle module may be used in a cleaning apparatus to clean and/or deburr workpieces in a cleaning tank filled with a liquid cleaning medium. The nozzle module includes a device for delivering fluid under relatively high pressure into the at least one first nozzle chamber. Additionally, the cleaning apparatus has an additional device for delivering liquid or gaseous fluid under relatively low pressure into the at least one second nozzle chamber.

In one example, to deburr a workpiece, liquid is delivered under high pressure, P_{F}, to the at least one first nozzle chamber in the nozzle module. The absolute pressure of the liquid, P_{F}, may range from 30 bar to 3000 bar. In this example, the at least one second nozzle chamber is provided with gaseous fluid at a positive pressure, P_{G} (relative to atmospheric pressure), that is preferably in a range from 0.01 bar to 50 bar. In this example, in order to clean workpieces with the nozzle module, liquid is delivered at a substantially high pressure, P_{F}, to the at least one first nozzle chamber, preferably in the range of 50 bar of 3000 bar, and the at least one second nozzle chamber is provided with cleaning liquid under a low pressure, P_{N}, that advantageously corresponds to the an absolute pressure value in a range from 1.0 bar to 30 bar.

To flood wash workpieces, in particular, the nozzle modules may be operated with a cleaning fluid (e.g., water) that is liquid under standard conditions. In this example, preferably, this cleaning fluid contains cleaning additives (e.g., surfactants, bases, etc.). In this example, the cleaning fluid, preferably, has a temperature between 30° C. and 120° C.

As set forth herein, an example apparatus for treating workpieces includes a nozzle module comprising a module body. The module body has a first nozzle chamber which, in turn, comprises a first nozzle mouth through which an axis extends. The first nozzle mouth has a first nozzle opening. The first nozzle chamber extends in a longitudinal direction along the axis and the first nozzle opening generates a high-pressure liquid jet in the direction of the axis onto a workpiece. The module body also includes a second nozzle chamber extending in the longitudinal direction. The example apparatus also includes a first device to deliver liquid under relatively high pressure into the first nozzle chamber to generate a high-pressure liquid jet. The example apparatus also includes a second device to deliver liquid or gaseous fluid under relatively low pressure into the second nozzle chamber to generate a low-pressure jet. The second nozzle chamber comprises a second nozzle mouth to face the workpiece. The second nozzle mouth has a second nozzle opening to generate the low-pressure fluid jet flowing at least partially along and contacting the high-pressure liquid jet.

In some examples, the second nozzle opening is coaxial with the axis of the first nozzle chamber to allow the low-pressure fluid jet to at least partially surround the high-pressure liquid jet. The example apparatus may also include a plurality of nozzle openings coaxial with the axis of the first nozzle chamber to allow a plurality of low-pressure fluid jets to flow along the high-pressure liquid jet. In some examples, the second nozzle chamber is disposed in a nozzle body having a third nozzle mouth with a tapered outer contour, in which the plurality of nozzle openings are located. In some examples, the plurality of low-pressure fluid jets that contact the high-pressure fluid jet, at least partially, are defined as ring segments or circle areas disposed around a common center. In some examples, the first nozzle opening is displaceable within the module body. In some examples, the first nozzle mouth is disposed in a rotatably movable manner and may be rotated about a rotation axis that is substantially parallel to a jet axis of the first nozzle mouth. In some examples, the first nozzle mouth is disposed in a linearly movable manner and may be moved along an axis that is substantially parallel to a jet axis of the second nozzle opening.

In some examples, the first nozzle mouth may be positioned in the module body. A first plane that comprises the first nozzle opening and that is perpendicular to the jet axis of the nozzle opening is located in front of or behind a second plane that comprises the second nozzle opening of the second nozzle chamber and perpendicular to the jet axis of the first nozzle mouth in the orientation of the flow direction of a high-pressure liquid jet emerging from the first nozzle opening. In some examples, the first nozzle opening has a circular shape, a lenticular shape, a quadrangular shape, a hexagonal shape or a star shape.

In some examples, the first nozzle chamber further comprises a third nozzle opening. The first and third nozzle openings generate a plurality of high-pressure liquid jets directed towards the workpiece. In some examples, the first nozzle chamber has a wall that extends at least partially through the second nozzle chamber. In some examples, the second nozzle opening has a ring or ring segment shape. In some examples, the nozzle module is used for one or more of cleaning and deburring workpieces.

One example method for treating a workpiece includes generating at least one first liquid jet at a relatively high pressure emerging from a first nozzle opening of a first nozzle chamber and directed onto the workpiece, and generating at least a first fluid jet at a relatively low pressure emerging from a second nozzle opening of a second nozzle chamber and directed onto the workpiece. The first fluid jet flows along and at least partially contacts the first liquid jet.

In some examples, the first fluid comprises a gaseous fluid to deburr the workpiece. In some examples, the first fluid jet comprises a cleaning liquid to clean the workpiece. In some examples, the first fluid jet at least partially surrounds the first liquid jet. In some examples, one or more of the first liquid jet and the first fluid jet is generated in a pulsing manner. In some examples, the first liquid jet is directed onto a portion of the workpiece that is immersed in a cleaning fluid. In some examples, the second nozzle opening is disposed in an offset manner with respect to the first nozzle opening. In some examples, the first fluid jet has, at the second nozzle opening, a first flow velocity that is less than a second flow velocity of the first liquid jet at the first nozzle opening.

Another example apparatus includes a nozzle module and a first nozzle chamber disposed within the nozzle module. The first nozzle chamber has a first nozzle opening and is to deliver a relatively high pressure fluid to the first nozzle opening. The example apparatus also includes a second nozzle chamber disposed within the nozzle module. The second nozzle chamber has a second nozzle opening and is to deliver a relatively low pressure fluid to the second nozzle opening. A first flow of the low pressure fluid at least partially contacts a second flow of the high pressure fluid. The second flow is directed onto a workpiece.

In some examples, one or more of the first flow and the second flow is generated in a pulsing manner. In some examples, the first flow has a lower flow velocity than the second flow. In some examples, the first nozzle chamber may also include a third nozzle opening. In some examples, the first or second nozzle opening comprises a circular shape, a lenticular shape, a quadrangular shape, a hexagonal shape, or a star shape. In some examples, the low pressure fluid comprises a gaseous fluid. In some examples, the first and second flows are directed toward a workpiece submerged in liquid.

Another example cleaning apparatus 100, 200 for treating (e.g., cleaning and/or deburring) workpieces 102, 202 includes a nozzle module 114, 214, which has a module body 116, 216. The module body has a nozzle chamber 120, 220 that, in turn, has at least one nozzle opening 146, 246 to generate at least one high-pressure liquid jet 148, 248 directed onto a workpiece 102, 202. The module body 116, 216 comprises a second nozzle chamber 124, 224, which has at least one nozzle opening 172, 272 for generating at least one low-pressure fluid jet 184, 184′, 284, 284′ flowing at least partially along and contacting the high-pressure liquid jet 148, 248 and a device 128, 228 for delivering liquid 130, 230 under high pressure into the nozzle chamber 120, 220 to generate the at least one high-pressure liquid jet 148, 248. The module body 116, 216 also has a second device 154, 254 for optionally delivering liquid 157 under low pressure or gaseous fluid 155 into the second nozzle chamber 124.

In some examples, the at least one low-pressure fluid jet 184, 184′, 284, 284′ at least partially surrounds the at least one high-pressure liquid jet 148, 248.

In some examples, the at least one nozzle opening 146, 246 that generates a high-pressure liquid jet 148, 248 is displaceable in the module body 116, 226.

In some examples, the at least one nozzle opening 146, 246 that generates a high-pressure liquid jet 148, 248 is located in a nozzle mouth 244 that is disposed in a rotatably movable manner and may be rotated about a rotation axis 271 that is preferably parallel to the jet axis 245 of the nozzle mouth 244.

In some examples, the at least one nozzle opening 146, 246 generates a high-pressure liquid jet 148, 248 and is located in a nozzle mouth 144, 244 disposed in a linearly movable manner, that may be moved along an axis 171, 271 substantially parallel to the jet axis 145, 245 of the nozzle mouth 144, 244.

Another example cleaning apparatus 100, 200 for treating (e.g., cleaning and/or deburring) workpieces 102, 202 includes a nozzle module 114, 214, which has a module body 116, 216. The module body 116, 216 comprises a nozzle chamber 120, 220 that has at least one nozzle opening 146, 246 for generating at least one high-pressure liquid jet 148, 248 directed onto the workpiece 102, 202. The module body 116, 216 comprises a second nozzle chamber 124, 224, which has at least one nozzle opening 172, 272 for generating at least one low-pressure fluid stream 184, 184′, 284, 284′ flowing at least partially along and contacting the high-pressure liquid jet 148, 248, and a device 128, 228 for delivering liquid 130, 230 under high pressure into the nozzle chamber 120, 220 to generate the at least one high-pressure liquid jet 148, 248. The at least one nozzle opening 146, 246 that generates a high-pressure liquid jet 148, 248 is located in a nozzle mouth 144, 244 disposed in a linearly movable manner that may be moved along an axis 171, 271 that is substantially parallel to the jet axis 145, 245 of the nozzle mouth 144, 244.

In some examples, the nozzle mouth 144 may be positioned in the module body 116 in such a manner that the plane 147, that comprises the nozzle opening 146 and that is perpendicular to the jet axis 171 of the nozzle mouth 144, is located in front of and/or in and/or behind a plane 173 that comprises the at least one nozzle opening 172 of the second nozzle chamber 124 and that is substantially perpendicular to the jet axis 171 of the nozzle mouth 144 in the orientation of the flow direction of a high-pressure liquid jet 148 emerging from the nozzle opening 146.

In some examples, the at least one nozzle opening 146 that generates a high-pressure liquid jet 148 has a circular shape, a lenticular shape, a quadrangular shape, a hexagonal shape or a star shape.

In some examples, the nozzle chamber 720 has a plurality of nozzle openings 746, 746′, 746″ for generating a plurality of high-pressure liquid jets directed onto the workpiece.

In some examples, the nozzle chamber 120, 220 has a wall 121, 221 that extends at least partially through the second nozzle chamber 124, 224.

In some examples, the at least one nozzle opening 370, 470 for generating the at least one low-pressure fluid jet 184, 184′, 284, 284′ flowing at least partially along and contacting the high-pressure liquid jet 148, 248 has a ring or ring segment shape.

In some examples, the at least one second nozzle chamber 524, 624 has a plurality of nozzle openings 470, 470′, 470″, 570, 570′, 570″, 670, 670′, 670″ for generating a plurality of low-pressure fluid streams 484, 485 flowing along the first fluid jet 448, 548, 648.

In some examples, the at least one second nozzle chamber 624 is disposed in a nozzle body 622 that has a nozzle opening 625 with a tapered outer contour, in which the plurality of nozzle openings 570, 570′, 570″ are located.

In some examples, the plurality of nozzle openings for generating a plurality of low-pressure fluid jets 484, 485 that contact the high-pressure fluid jet 484, at least partially, are defined as ring segments 470, 470′, 470″ or circle areas 570, 570′, 570″ disposed around a common center 444, 544.

Another example method for deburring a workpiece 102, 202 includes generating at least one high-pressure liquid jet 148, 248 directed onto a workpiece (102, 103), and generating at least one low-pressure fluid jet 184, 184′, 284, 284′ composed of a gaseous fluid, in particular, compressed air that flows along, contacts and/or surrounds the high-pressure liquid jet 148, 248, at least partially.

Another example method for cleaning a workpiece 102, 202 includes generating a high-pressure liquid jet 148, 248, directed onto the workpiece 102, 103, and generating at least one low-pressure fluid jet 184, 184′, 284, 284′ composed of a cleaning liquid, in particular, water mixed with a cleaning additive.

In some examples, the high-pressure liquid jet (148, 248) and/or the low-pressure fluid jet (184, 184′, 284, 284′) is generated in a pulsing manner.

In some examples, the at least one high-pressure liquid jet 148, 248 is directed onto a portion of the workpiece 102 immersed in a cleaning fluid 104.

In some examples, the low-pressure fluid jet 184, 184′ is provided through a nozzle opening 370 disposed in an offset manner with respect to the nozzle opening for the high-pressure liquid jet 148, 248.

In some examples, the low-pressure fluid jet 184, 184′ provided at the nozzle opening has a flow velocity at the nozzle opening that is less than the flow velocity of the high-pressure liquid jet 148, 248 at the nozzle opening.

It is noted that this patent claims priority from International Patent Application No. PCT/EP2012/061355, which was filed on Jun. 14, 2012, which claims priority to German Patent Application No. 10 2011 078 076, which was filed on Jun. 24, 2011. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus for treating workpieces comprising:
a nozzle module comprising a module body having a first nozzle chamber, the first nozzle chamber comprising a first nozzle mouth through which an axis extends, the first nozzle mouth having a first nozzle opening, the first nozzle chamber extending in a longitudinal direction along the axis, the first nozzle opening to generate a high-pressure liquid jet in the direction of the axis onto a workpiece, wherein the module body comprises a second nozzle chamber extending in the longitudinal direction;
a first device to deliver liquid under relatively high pressure into the first nozzle chamber to generate a high-pressure liquid jet; and
a second device to deliver liquid or gaseous fluid under relatively low pressure into a second nozzle chamber to generate a low-pressure fluid jet, wherein the second nozzle chamber comprises a second nozzle mouth to face the workpiece, the second nozzle mouth having a second nozzle opening to generate the low-pressure fluid jet flowing at least partially along and contacting the high-pressure liquid jet.

2. The apparatus as defined in claim 1, wherein the second nozzle opening is coaxial with the axis of the first nozzle chamber to allow the low-pressure fluid jet to at least partially surround the high-pressure liquid jet.

3. The apparatus as defined in claim 1, further comprising a plurality of nozzle openings coaxial with the axis of the first nozzle chamber to allow a plurality of low-pressure fluid jets to flow along the high-pressure liquid jet.

4. The apparatus as defined in claim 3, wherein the second nozzle chamber is disposed in a nozzle body having a third nozzle mouth with a tapered outer contour, in which the plurality of nozzle openings are located.

5. The apparatus as defined in claim 3, wherein the plurality of low-pressure fluid jets that contact the high-pressure fluid jet, at least partially, are defined as ring segments or circle areas disposed around a common center.

6. The apparatus as defined in claim 1, wherein the first nozzle opening is displaceable within the module body.

7. The apparatus as defined in claim 1, wherein the first nozzle mouth is disposed in a rotatably movable manner and may be rotated about a rotation axis that is substantially parallel to the jet axis of the first nozzle mouth.

8. The apparatus as claimed in claim 1, wherein the first nozzle mouth is disposed in a linearly movable manner and may be moved along an axis that is substantially parallel to a jet axis of the second nozzle opening.

9. The apparatus as defined in claim 8, wherein the first nozzle mouth may be positioned in the module body, wherein a first plane that comprises the first nozzle opening and that is perpendicular to the jet axis of the first nozzle mouth is located in front of or behind a second plane that comprises the second nozzle opening of the second nozzle chamber and perpendicular to the jet axis of the first nozzle mouth in the orientation of the flow direction of a high-pressure liquid jet emerging from the first nozzle opening.

10. The apparatus as defined in claim 1, wherein the first nozzle opening has a circular shape, a lenticular shape, a quadrangular shape, a hexagonal shape or a star shape.

11. The apparatus as defined in claim 1, wherein the first nozzle chamber further comprises a third nozzle opening to generate a plurality of high-pressure liquid jets directed towards the workpiece.

12. The apparatus as defined in claim 1, wherein the first nozzle chamber has a wall that extends at least partially through the second nozzle chamber.

13. The apparatus as defined in claim 1, wherein the second nozzle opening has a ring or ring segment shape.

14. The use of an apparatus as defined in claim 1 wherein the nozzle module is used for one or more of cleaning and deburring workpieces.

15. A method for treating a workpiece comprising:
generating at least a first liquid jet at a relatively high pressure emerging from a first nozzle opening of a first nozzle chamber and directed onto the workpiece; and
generating at least a first fluid jet at a relatively low pressure emerging from a second nozzle opening of a second nozzle chamber and directed onto the workpiece, wherein the first fluid jet flows along and at least partially contacts the first liquid jet.

16. The method as defined in claim 15, wherein the first fluid jet comprises a gaseous fluid to deburr the workpiece.

17. The method as defined in claim 15, wherein the first fluid jet comprises a cleaning liquid to clean the workpiece.

18. The method as defined in claim 15, wherein the first fluid jet at least partially surrounds the first liquid jet.

19. The method as defined in claim 15, wherein one or more of the first liquid jet and the first fluid jet is generated in a pulsing manner.

20. The method as defined in claim 15, wherein the first liquid jet is directed onto a portion of the workpiece that is immersed in a cleaning fluid.

21. The method as defined in claim 15, wherein the second nozzle opening is disposed in an offset manner with respect to the first nozzle opening.

22. The method as defined in claim 15, wherein the first fluid jet has, at the second nozzle opening, a first flow velocity that is less than a second flow velocity for the first liquid jet at the first nozzle opening.

23. An apparatus comprising:
a nozzle module;
a first nozzle chamber disposed within the nozzle module and having a first nozzle opening, the first nozzle chamber to deliver a relatively high pressure fluid to the first nozzle opening; and
a second nozzle chamber disposed within the nozzle module and having a second nozzle opening, the second nozzle chamber to deliver a relatively low pressure fluid to a second nozzle opening,
wherein a first flow of the low pressure fluid at least partially contacts a second flow of the high pressure fluid, the second flow directed onto a workpiece.

24. The apparatus as defined in claim 23, wherein one or more of the first flow and the second flow is generated in a pulsing manner.

25. The apparatus as defined in claim 23, wherein the first flow has a lower flow velocity than the second flow.

26. The apparatus as defined in claim 23, wherein the first nozzle chamber further comprises a third nozzle opening.

27. The apparatus as defined in claim 23, wherein the first or second nozzle opening comprises a circular shape, a lenticular shape, a quadrangular shape, a hexagonal shape, or a star shape.

28. The apparatus as defined in claim 23, wherein the low pressure fluid comprises a gaseous fluid.

29. The apparatus as defined in claim 23, wherein the first and second flows are directed toward a workpiece submerged in liquid.
